(19) United States
(12) Patent Application Publication
(10) Pub. No.: US 2009/0290556 A1
(43) Pub. Date: Nov. 26, 2009

(54) WIRELESS NETWORK HANDOVER WITH SINGLE RADIO OPERATION

(76) Inventor: Pouya Taaghol, San Jose, CA (US)

Correspondence Address: COOL PATENT, P.C.;c/o CPA Global, P.O. BOX 52050, MINNEAPOLIS, MN, 55402, US

(21) Appl. No.: 12/126,737

(22) Filed: May 23, 2008

(51) Int. Cl. H04Q 7/00

(52) U.S. Cl. 370/331

(57) ABSTRACT

Briefly, in accordance with one or more embodiments, a handover of a wireless device from a first network to a second network may be implemented via operation of a single radio in the wireless device. A network architecture capable of implementing such a single radio handover operation may comprise a mobility management entity of a first network and an interworking function device capable of emulating an authenticator and/or protocol translation device of the first network or a second network. First switching logic is capable of exchanging information between the mobile station and the internetworking function device during a handover operation, and second switching logic is capable of exchanging information between the internetworking function device and an ASN, RNC, and/or SGSN of the target network.

### BACKGROUND

Mobile services providers typically may operate several heterogeneous access technologies and networks. Worldwide Interoperability for Microwave Access (WiMAX) is a wireless communication access technology intended to be deployed in accordance with the Institute of Electrical and Electronics Engineers (IEEE) standard referred to as IEEE 802.16. WiMAX is targeted to provide broadband wireless communication over longer distances. The initial WiMAX deployment may cover only limited areas of service that may already be currently serviced by the third generation (3G) type cellular networks, such as promulgated by the 3^{rd} Generation Partnership Project (3GPP). For example, at least during initial deployment of WiMAX networks, islands of WiMAX coverage areas would exist within cellular 3G oceans. Hence, it may be useful for a 3G network service provider that deploys WiMAX services to converge WiMAX access and 3G access with seamless vertical mobility, or interaccess. Furthermore, dual mode devices that are capable of communicating with both 3G networks and WiMAX networks are expected to be deployed.

Current solutions for network interaccess in 3GPP standards and the cellular industry utilize Layer 3 (L3) protocols (i.e., client-based Mobile IP) for providing mobility between access technologies. However, such client-based Mobile IP methods require simultaneous radio operation of both access technologies to execute a handover operation which may not be possible for the mobile platform to perform due to coexistence and/or interference issues between two heterogeneous wireless networks and radio equipment. Furthermore, client-based Mobile IP techniques may experience a great deal of latency in performing interaccess handovers, typically on the order of several seconds, that could hinder operation of real-time services such as Voice over Internet Protocol (VOIP) applications or the like.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a block diagram of a wireless network illustrating a handover between two or more heterogeneous wireless networks in accordance with one or more embodiments;

FIG. 2 is a block diagram of an architecture of a wireless network capable of handling a handover between another wireless network in accordance with one or more embodiments;

FIG. 3 is a flow diagram of a method to implement a handover from a 3GPP type network to a WiMAX type network in accordance with one or more embodiments; and

FIG. 4 is a flow diagram of a method to implement a handover from a WiMAX type network to a 3GPP type network in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

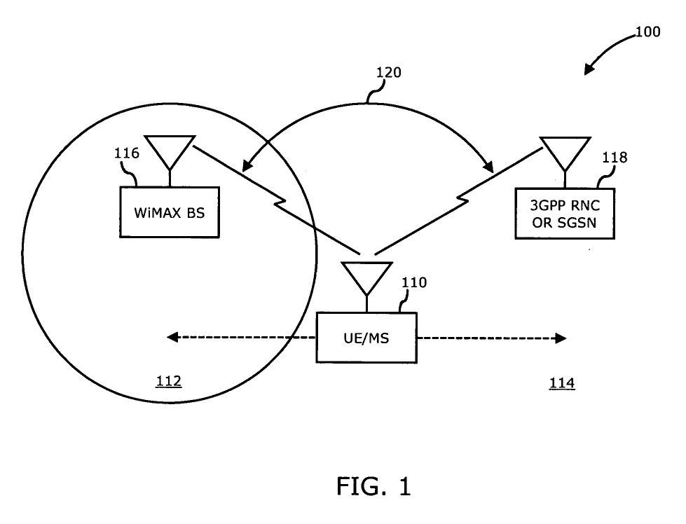

Referring now to FIG. 1, a block diagram of a wireless network illustrating a handover between two or more heterogeneous wireless networks in accordance with one or more embodiments will be discussed. As shown in FIG. 1, wireless network 100 may comprise a WiMAX network coverage area 112 disposed in and/or proximate to a 2G/3G network coverage area 114. WiMAX network coverage area 112 may be serviced by a WiMAX Base Station (WiMAX BS) 116, and likewise 3G network coverage area 114 may be serviced by a 3GPP Radio Network Controller (3GPP RNC) 118. Alternatively, for General Packet Radio Service (GPRS) access, 3GPP RNC 118 may include or comprise a Serving GPRS Support Node (SGSN). Other types of #G type services may likewise be implemented, for example Universal Mobile Telecommunications System (UMTS), High-Speed Downlink Packet Access (HSDPA), High-Speed Uplink Packet Access (HSUPA), 3GPP Long Term Evolution (3GPP LTE), and so on, although the scope of the claimed subject matter is not limited in this respect.

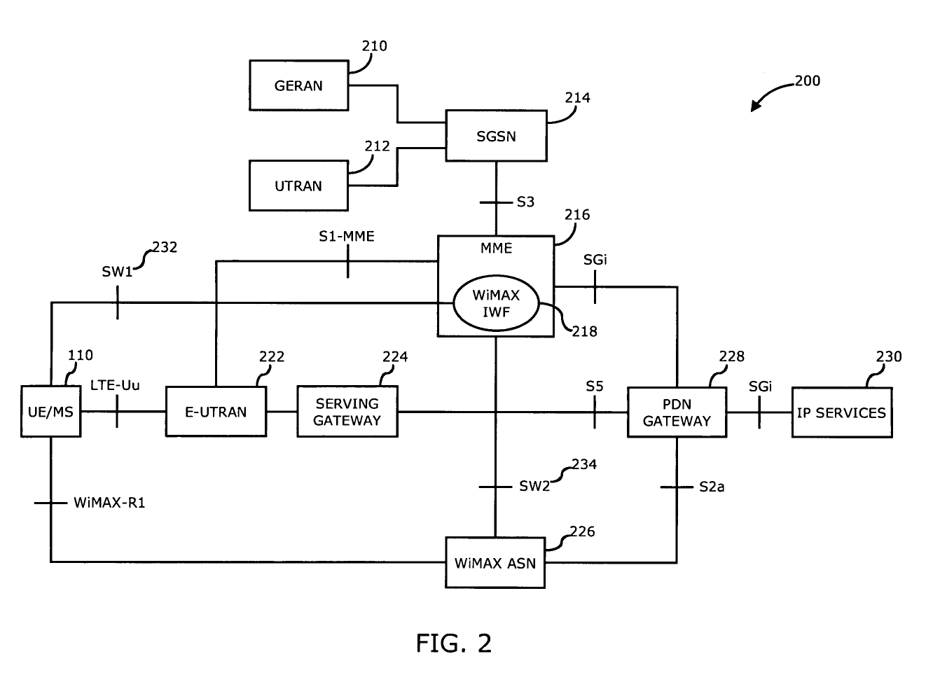

In one or more embodiments, a mobile station (MS) 110 may move between WiMAX network coverage area 112 and 3G network coverage area 114. If mobile station 110 moves from WiMAX coverage area 112 to 3G network coverage area 114, or if mobile station 110 movies from 3G network coverage area 114 to WiMAX coverage area 112, a handover operation 120 may occur between the WiMAX network to the 3G network, of from the 3G network to the WiMAX network. In one or more embodiments, handover operation 120 may implement an optimized handover method between WiMAX and 3GPP services where the mobile station 110 may have one radio active at any given time. To enable single radio operation that a single radio module of a multi-communication platform is on at any given time, inter-radio access technology (inter-RAT) info exchange may be utilized. An example architecture of a wireless network capable of implementing a handover between access services is discussed with respect to FIG. 2, below.

Referring now to FIG. 2, a block diagram of an architecture of a wireless network capable of handling a handover between another wireless network in accordance with one or more embodiments will be discussed. In one particular embodiment, FIG. 2 illustrates demonstrates architectural enhancements of a 3GPP Enhanced Packet Core (EPC) 200. EPC is the architecture evolution of 3GPP systems being standardized as apart of 3GPP Release 8. It should be noted that not all of the components of 3GPP EPC 200 are illustrated in FIG. 2, and that FIG. 2 shows the components involved for vertical handover with a WiMAX network. In one or more embodiments, a WiMAX Internetworking Function (WiMAX IWF) is added to Mobility Management Entity (MME) 218 of 3GPP network 200. Alternatively, WiMAX IWF 218 may be disposed outside, or at least partially outside, of the MME 218. WiMAX IWF 218 is capable of emulating the function of WiMAX access service network (ASN) 226 for handovers 120 from 3GPP services to WiMAX services. Likewise, WiMAX IWF 218 is capable of emulates the function of the Radio Network Controller (RNC) or Serving GPRS Support Node (SGSN) 214 in handovers from WiMAX services to 3GPP services. Furthermore, two interfaces are utilized to facilitate the processes involved in handover 120. In one or more embodiments, switch SW1 232 comprises a logical interface between the mobile station and/or user equipment (UE/MS) 110 and WiMAX IWF 218 for handover related communication. Likewise, switch SW2 234 is utilized for exchange of information of context between WiMAX IWF 218 and WiMAX ASN 226. In one or more embodiments, the interface implemented by switch SW2 234 may be based on a WiMAX inter-ASN (WiMAX R4) interface, although the scope of the claimed subject matter is not limited in this respect. To complete 3GPP network 200, SGSN 214 couples to GSM EDGE Radio Access Network (GERAN) 210 and to UMTS Terrestrial Radio Access Network (UTRAN) 212. User equipment and/or mobile station 110 couples to evolved-UTRAN (E-UTRAN) 222 which in turn couples to serving gateway 224. Serving gateway 224 couples to public data network gateway (PDN Gateway) 228 which is coupled with Internet Protocol Services (IP Services) 230 to allow user equipment and/or mobile station 110 to connect to the internet, although the scope of the claimed subject matter is not limited in this respect.

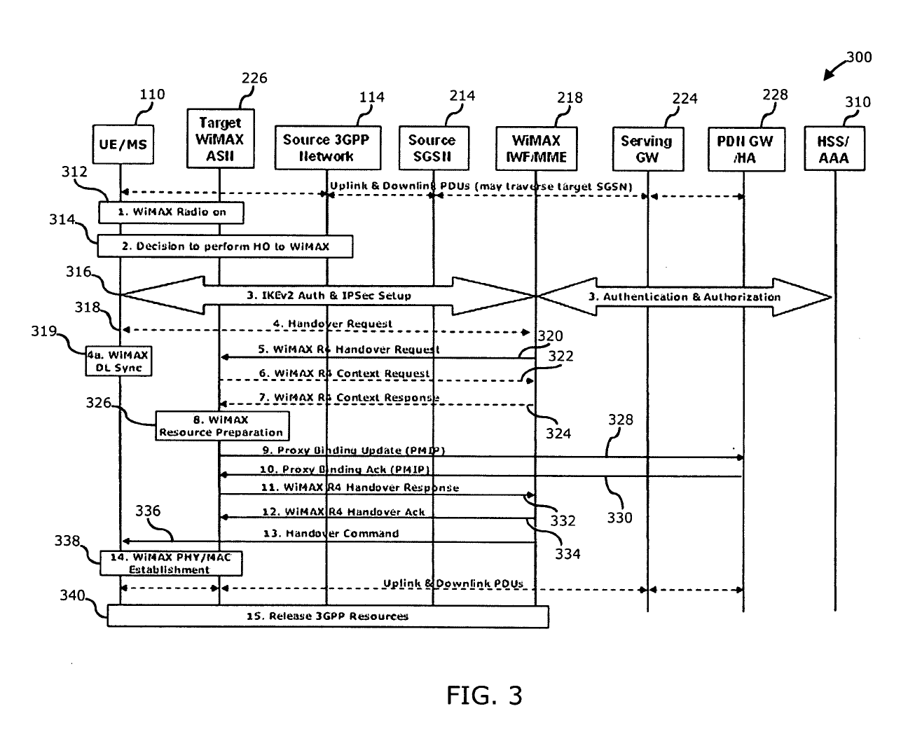

Referring now FIG. 3, a flow diagram of a method to implement a handover from a 3GPP type network to a WiMAX type network in accordance with one or more embodiments will be discussed. It should be noted that the method 300 as shown in FIG. 3 represents one particular procedure for implementing a handover 120 between two access technologies such as between a WiMAX network and a 3GPP network or the like, however other variations of method 300 may be implemented with more or fewer procedures than shown in FIG. 3, and/or in a different order of the procedures, and the scope of the claimed subject matter is not limited in this respect. Furthermore, it should be noted that the procedures shown in FIG. 3 with dashed lines are optional and may or may not be implemented in some applications. In one or more embodiments, at procedure 310 3GPP connected user equipment and/or mobile station (UE/MS) 110 performs network discovery and determines that WiMAX access is available in present coverage area 112. At procedure 314, a decision is made to perform a vertical handover 120 to WiMAX services. The decision for handover 120 may be made by UE/MS 110, by the source 3GPP network 114, and/or assisted either way, although the scope of the claimed subject matter is not limited in this respect. At procedure 316, an IKEv2 procedure may be initiated by the UE/MS 110. In this procedure, the UE/MS 110 may be authenticated using an Extensible Authentication Protocol (EAP)-Authentication and Key Agreement (AKA) method. WiMAX IWF 218 functions as the EAP authenticator and generates the key derivates that are involved. At or near the end of procedure 316, an IPSec tunnel may be set up between the UE/MS 110 and WiMAX IWF 218 for secure communication.

Optionally an explicit handover request is sent at procedure 318 to from the WiMAX IWF 218 to UE/MS 110 or vice versa. Such an explicit handover request message may be useful if the Internet Protocol Security (IPSec) tunnel between UE/MS 110 and WiMAX IWF 218 remains open. In this message, the details of the target WiMAX BS 116 context can be sent. After procedure 316, UE/MS 110 is aware of the target WiMAX BS 116 and it can start downlink synchronization (WiMAX DL Sync) to the target WiMAX BS 166 in the 3GPP idle periods at procedure 319. At procedure 320, WiMAX IWF 218 determines the correct target WiMAX ASN 226 based at least in part on the address of the target WiMAX BS 116. Subsequently, WiMAX IWF 218 sends the message of a WiMAX R4 Handover Request to the Target WiMAX ASN 226. Upon receipt of the message, Target WiMAX ASN 226 may request further context of US/MS 110 by sending a WiMAX R4 Context Request at procedure 322. WiMAX IWF 218 responds at procedure 324 to the context request by including the detailed context of the UE/MS 110 in the message WiMAX R4 Context Response. At procedure 326, Target WiMAX ASN 226 prepares radio resources and sets up a data path, and at procedure 328, a Gateway of the Target WiMAX ASN 226 starts Proxy Mobile IP Protocol (PMIP) tunneling by sending a Proxy Binding Update to PDN Gateway (PDN GW) 228 which acts as the Mobile IP Home Agent (HA). The PDN GW 228 responds with Proxy Binding Acknowledgement to the Gateway of the Target WiMAX ASN 226, which includes IP address for the UE/MS 100, which may be the same IP address that was allocated to the 3GPP connection for the present UE/MS 110.

In one or more embodiments, Target WiMAX ASN 226 informs WiMAX IWF 218 of WiMAX preparation completion by sending WiMAX R4 Handover Response at procedure 332. WiMAX IWF 218 acknowledges completion of WiMAX resource reservation at procedure 332 by sending WiMAX R4 Handover Acknowledgement. At procedure 336, WiMAX IWF 218 commands the UE/MS 110 to switch to WiMAX services. Relevant configuration information may be sent to the UE/MS in this message. At procedure 338, UE/MS 110 starts the uplink synchronization process and/or related procedures related to a WiMAX optimized handover, and then 3GPP resources are released at procedure 338 anytime after completion of the handover command executed at procedure 336. Likewise, the IPSec tunnel of procedure 316 may be shut down after completion of handover 120, although the scope of the claimed subject matter is not limited in this respect. In one or more embodiments, method 300 of FIG. 3 may be executed in less than 50 milliseconds, although the scope of the claimed subject matter is not limited in this respect.

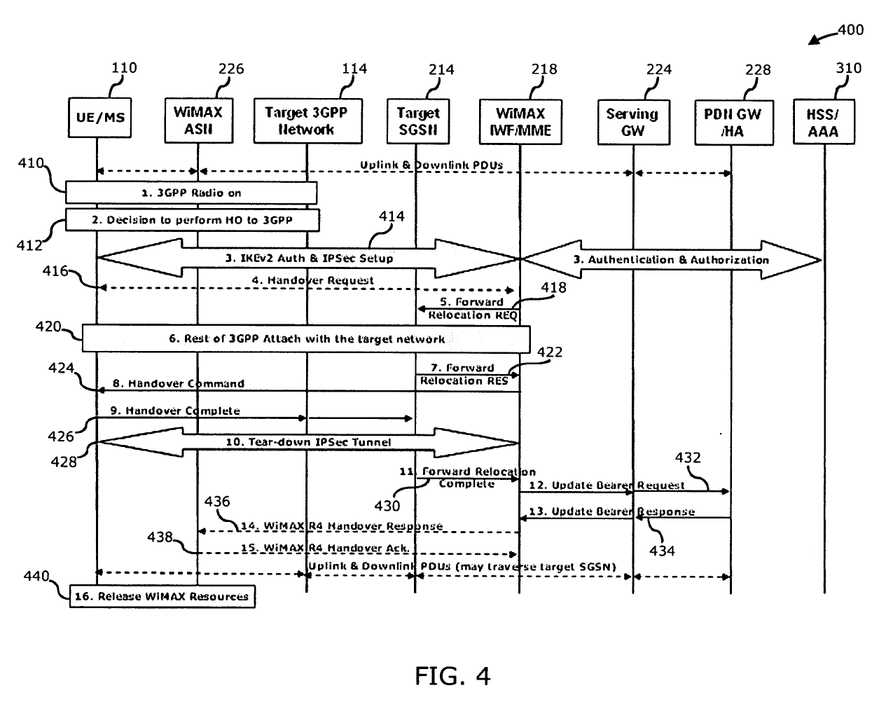

Referring now to FIG. 4, a flow diagram of a method to implement a handover from a WiMAX type network to a 3GPP type network in accordance with one or more embodiments will be discussed. The method 400 shown in FIG. 4 is similar to method 300 of FIG. 3 except the handover 120 occurs from WiMAX network 112 to 3GPP network 114. It should be noted that the method 400 as shown in FIG. 4 represents one particular procedure for implementing a handover 120 between two access technologies such as between a WiMAX network and a 3GPP network or the like, however other variations of method 400 may be implemented with more or fewer procedures than shown in FIG. 4, and/or in a different order of the procedures, and the scope of the claimed subject matter is not limited in this respect. Furthermore, it should be noted that the procedures shown in FIG. 4 with dashed lines are optional and may or may not be implemented in some applications. At procedure 410, the WiMAX connected user equipment and/or mobile station (UE/MS) 110 performs network discovery and determines that 3GPP access services are available in the present coverage area. At procedure 412, a decision is made to perform a vertical handover 120 to 3GPP services. This decision can be made by the ULE/MS 110, by WiMAX network 112, and/or assisted either way, although the scope of the claimed subject matter is not limited in this respect. In one or more embodiments, an IKEv2 process is initiated at procedure 414 by UE/MS 110. During this procedure, UE/MS 110 may be is authenticated using an Authentication and Key Agreement (AKA) method, although the scope of the claimed subject matter is not limited in this respect. WiMAX IWF 218 functions as the authenticator for SGSN 214 and generates the key derivates are involved. At the end of procedure 414, an IPSec tunnel may be set up between the UE/MS 110 and WiMAX IWF 218 for secure communication.

Optionally in one or more embodiments, an explicit handover request is sent at procedure 416 from WiMAX IWF 218 to UE/MS 110 or vice versa. Such a message may be useful if the IPSec tunnel between UE/MS 110 and the WiMAX IWF 218 remains open. In this message, the details of context of the target SGSN 214 can be sent. After procedure 416, UE/MS 110 is aware of the target SGSN 214, and UE/MS 110 can start downlink synchronization to the target SGSN 214 in WiMAX idle periods. At procedure 418 the handover to 3GPP network 114 optionally may be initiated by the WiMAX network 112 and/or by UE/MS 110 in which case an R4 WiMAX Handover Request is sent from WiMAX ASN 226 to WiMAX IWF 218. At procedure 420, the rest of a 3GPP attach procedure between UE/MS 110 and WiMAX IWF 218 may be performed. At procedure 422, WiMAX IWF 218 determines the correct target SGSN 214 based at least in part on the address target 3GPP RNC 118. Subsequently, WiMAX IWF 218 sends the message of Forward Relocation Request to the target SGSN 214. At procedure 424, the target SGSN 214 prepares the radio resources of the target 3GPP network 1124 and sets up a data path. At procedure 426, the target SGSN 214 sends the a Forward Relocation Response to the WiMAX IWF 218, and in response WiMAX IWF 218 triggers the data path establishment at procedure 428 by sending Create Default Bearer Request (REQ). It should be noted that procedure 428 may be optionally implemented and in some embodiments procedure 428 may not be implemented. The Serving Gateway 224 starts the Proxy Mobile IP Protocol (PMIP) tunneling at procedure 430 by sending a Proxy Binding Update to PDN GW 228 which acts as the Mobile IP Home Agent (HA). In the case of GPRS Tunneling Protocol (GTP), Create Bearer Request is sent by the PDN GW 228. PDN GW 228 responds at procedure 432 with Proxy Binding Acknowledgement to the Serving Gateway 224 which includes IP address for UE/MS 110 which may be the same IP address that was allocated to the 3GPP connection for the present MS/UE 110. In the case of GTP, Create Bearer Response is sent by the PDN GW 228. At procedure 434, Serving GW 224 responds to WiMAX IWF 218 by a Create Default Bearer Response which indicates the completion of the data path.

In one or more embodiments, at procedure 436 WiMAX IWF 218 commands UE/MS 110 to switch to 3GPP network 114. Relevant configuration information may be sent to the UE/MS 110 in this message. At procedure 438, UE/MS 110 sends a Handover Complete message to the target 3GPP network 114. In the event procedure 418 is executed, WiMAX IWF 218 may respond to WiMAX ASN 226 about the completion of handover procedures via a WiMAX R4 Handover Response. In such a case WiMAX ASN 226 confirms the handover completion by via a WiMAX R4 Handover Acknowledgment (Ack). WiMAX resources may be released anytime after execution of procedure 440. Furthermore, the IPSec tunnel set up during procedure 414 may be taken down after completion of the handover. In one or more embodiments, method 400 of FIG. 4 may be executed in less than 50 milliseconds, although the scope of the claimed subject matter is not limited in this respect.

Although the claimed subject matter has been described with a certain degree of particularity, it should be recognized that elements thereof may be altered by persons skilled in the art without departing from the spirit and/or scope of claimed subject matter. It is believed that the subject matter pertaining to a wireless network handover with single radio operation and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. A method, comprising:
in response to a decision to perform a handover of a mobile station from a present network to a target Worldwide Interoperability for Microwave Access (WiMAX) network, authenticating a mobile station on the target WiMAX network using an interworking function as the WiMAX network authenticator;
determining a target base station of a WiMAX access service network (ASN) for the mobile station to communicate with;
sending a handover request to the target WiMAX ASN to request the WiMAX ASN to allocate radio resources to the mobile station; and
upon allocation of radio resources, commanding the mobile station to switch to communication with the target base station of the WiMAX ASN.

2. A method as claimed in claim 1, further comprising sending details of the target base station to the mobile station via an explicit handover request.

3. A method as claimed in claim 1, wherein said authenticating comprises arranging a secure tunnel between the mobile station and the interworking function.

4. A method as claimed in claim 1, wherein the handover request comprises downlink synchronization between the target base station and the mobile station.

5. A method as claimed in claim 1, wherein the allocation of radio resources comprises implementing proxy mobile IP protocol tunneling.

6. A method as claimed in claim 1, further comprising releasing the resources of the present network after handover of the mobile station to the target WiMAX network.

7. A method, comprising:
in response to a decision to handover a mobile station from a present network to a target third generation (3G) network, authenticating the mobile station on the target 3G network using an interworking function as the 3G network authenticator;
determining a target base station of a 3G access service network (ASN) for the mobile station to communicate with;
sending a handover request to the target 3G ASN to request the 3G ASN to allocate radio resources to the mobile station; and
upon allocation of radio resources, commanding the mobile station to switch to communication with the target base station of the 3G ASN.

8. A method as claimed in claim 7, further comprising sending details of the target base station to the mobile station via an explicit handover request.

9. A method as claimed in claim 7, wherein said authenticating comprises arranging a secure tunnel between mobile station and the interworking function.

10. A method as claimed in claim 7, wherein the handover request comprises downlink synchronization between the target base station and the mobile station.

11. A method as claimed in claim 7, wherein the allocation of radio resources comprises implementing proxy mobile internet protocol (IP) protocol tunneling.

12. A method as claimed in claim 7, further comprising releasing the resources of the present network after handover of the mobile station to the target 3G network.

13. An apparatus, comprising:
a mobility management entity of a first network;
an interworking function device coupled to the mobility management network, the internetworking function device being capable of emulating an authenticator device of the first network or a second network;
first switching logic capable of exchanging information between a mobile station and the internetworking function device during a handover of the mobile station between the first network and the second network; and
second switching logic capable of exchanging information between the internetworking function device and an access service network (ASN) of the second network during handover of the mobile station between the first network and the second network.

14. An apparatus as claimed in claim 13, wherein the first network comprises a third generation (3G) type network, or the second network comprises a Worldwide Interoperability for Microwave Access (WiMAX) type network, or combinations thereof.

15. An apparatus as claimed in claim 13, wherein the internetworking function device is implemented by the mobility management entity of the first network.

16. An apparatus as claimed in claim 13, wherein the internetworking function device is implemented at least in part by a device separate from the mobility management entity of the first network.

17. An apparatus as claimed in claim 13, wherein the internetworking device is capable of emulating an authentication device of the second network during a handover of the mobile station from the first network to the second network, or is capable of emulating an authentication device of the first network during a handover of the mobile station from the second network to the first network, or combinations thereof.

18. An apparatus as claimed in claim 13, wherein the ASN comprises a WiMAX ASN.

19. An apparatus as claimed in claim 13, wherein second network comprises a WiMAX network, and the interworking function device is capable of emulating the function of the ASN of the WiMAX network for handover of the mobile station from the first network to the second network.

20. An apparatus as claimed in claim 13, wherein the first network comprises a third generation (3G) type network, and the interworking function device is capable of emulating the function of a radio network controller of the 3G type network, or the function of a service general packet radio service support note (SGSN) of the 3G type network, or combinations thereof, during handover of the mobile station from the second network to the first network.
